(19) United States
(12) Patent Application Publication
(10) Pub. No.: US 2016/0084323 A1
(43) Pub. Date: Mar. 24, 2016

(54) TRANSMISSION DAMPER

(71) Applicant: Metaldyne, LLC, Plymouth, MI (US)

(72) Inventors: Randy Cortright, South Lyon, MI (US); Steve Chevalier, Britton, MI (US)

(73) Assignee: Metaldyne, LLC, Plymouth, MI (US)

(21) Appl. No.: 14/490,017

(22) Filed: Sep. 18, 2014

(51) Int. Cl. F16D 13/58; F16D 13/10; F16F 15/173; F16F 15/126

(52) U.S. Cl. CPC F16D 13/58; F16F 15/126; F16D 13/10; F16F 15/173; F16D 2300/22

(57) ABSTRACT

A clutch damper is configured to dampen unwanted noise and vibration within a clutch assembly. The clutch damper includes an inertia member and an elastomeric member positioned about the inertia member. The damper may be connected to a hub located on a shaft within the clutch assembly.

### FIELD OF THE INVENTION

The present invention relates generally to a dampening device for clutch assemblies and specifically to an elastomeric or fluid/viscous damper for reducing or eliminating torsional and bending vibration frequencies during clutch engagement and disengagement.

### BACKGROUND OF THE INVENTION

Automobile transmission systems, specifically automatic transmission systems, include gear elements, such as planetary gears, and selectively engageable friction elements or clutches that are controlled to establish one of several forward speed ratios between the transmission input and output shafts. The input shaft is typically coupled to the vehicle engine through a fluid coupling such as a torque converter, and the output shaft is coupled to the vehicle drive wheels through a differential gear set.

Shifting from a currently established speed ratio to a new speed ratio involves, in most cases, disengaging a clutch associated with the current speed ratio and engaging a clutch associated with the new speed ratio. Engagement and disengagement of a clutch may result in unwanted noise and vibration, such as vibrations caused by contact between the transmission hub and one or more plate components, such as discs or steel pairs.

Therefore, an improvement in the art is needed to address this problem.

### SUMMARY

A clutch damper is generally provided to dampen unwanted noise and vibration within a clutch assembly. The clutch damper may be connected to a hub located on a shaft within the clutch assembly.

In an embodiment, the clutch damper includes an inertia member and an elastomeric member positioned about the inertia member. The elastomeric member may be connected to an inner wall of a hub, or optionally a mounting ring may be positioned between the elastomeric member and the hub to facilitate mounting to the hub. The mass of the inertia member and thickness and stiffness of the elastomeric member may be tuned to dampen objectionable or unwanted vibration frequencies within the clutch assembly.

In an embodiment, the clutch damper includes a housing comprising a hollow annular ring having a cavity therein. An inertia member is positioned within the cavity along with a viscous fluid. The mass of the inertia member, viscosity of the fluid, and fluid pressure within the cavity may be tuned to dampen objectionable or unwanted vibration frequencies within the clutch assembly.

### DESCRIPTION OF THE DRAWINGS

Operation of the invention may be better understood by reference to the following detailed description taken in connection with the following illustrations, wherein:

FIG. 1 illustrates a clutch assembly.

FIG. 2 illustrates a perspective cross-sectional view of a hub.

FIG. 3 illustrates a cross-sectional view of an elastomeric clutch damper.

FIG. 4 illustrates a perspective view of an elastomeric clutch damper.

FIG. 5 illustrates an exploded view of an elastomeric clutch damper.

FIG. 6 illustrates a cross-sectional view of an alternative construction for an elastomeric clutch damper.

FIG. 7 illustrates a cross-sectional view of a viscous clutch damper.

FIG. 8 illustrates a cross-sectional perspective view of a viscous clutch damper.

### DETAILED DESCRIPTION

While the invention is described herein with reference to several embodiments, it should be clear that the invention should not be limited only to the embodiments disclosed or discussed. The description of the embodiments herein is illustrative of the invention and should not limit the scope of the invention as described or claimed.

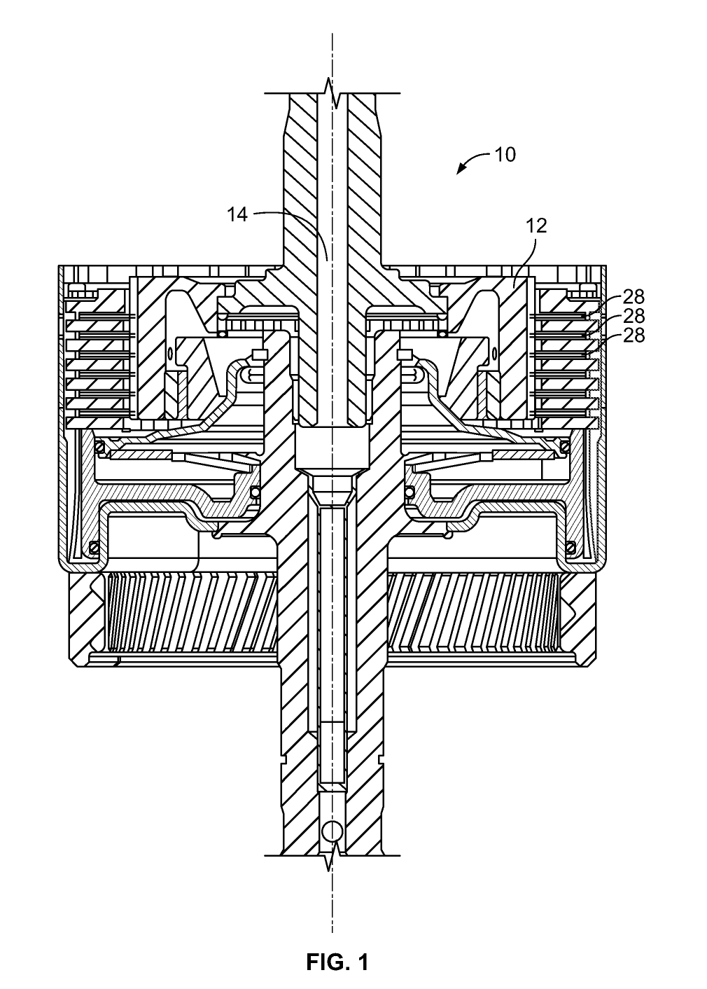

FIG. 1 generally depicts a clutch assembly 10 within an automobile transmission, such as an automatic transmission. The clutch assembly 10 includes a clutch hub 12 that is positioned about a shaft 14, such as a drive shaft. The drive shaft 14 may be connected to and driven by a vehicle engine and configured to rotate about an axis. The hub 12 may be connected to the shaft 14 and be configured to rotate therewith.

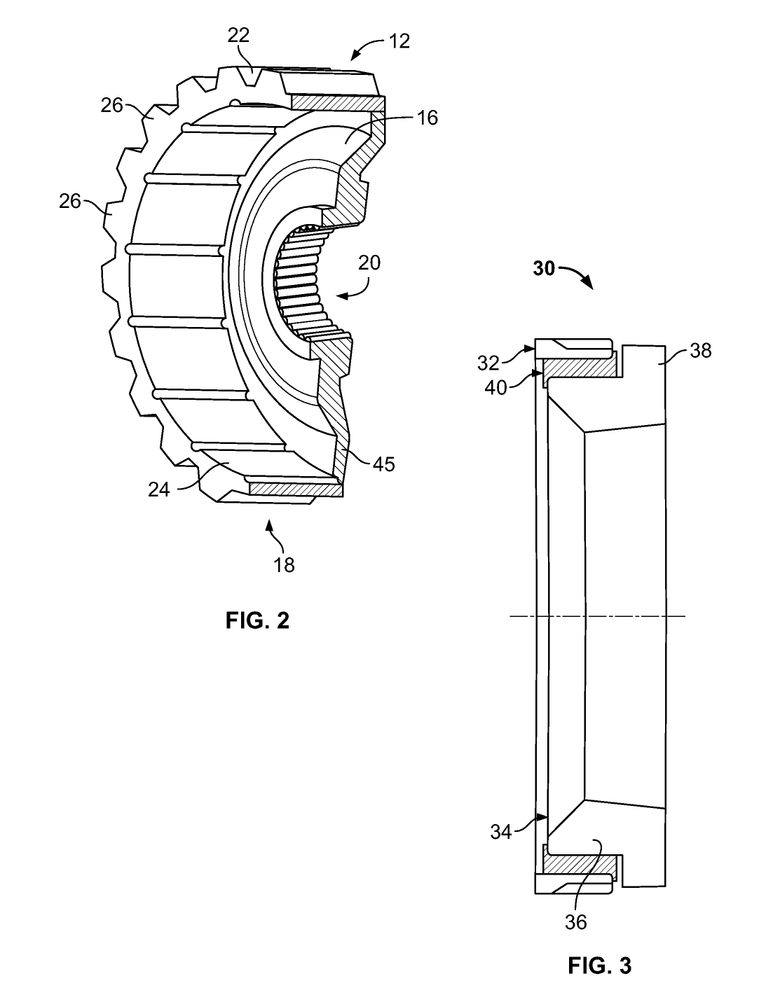

The hub 12 may be any appropriate size and shape, such as generally cylindrical, as shown in FIG. 2. The hub 12 may include a base 16 having a circular shape, and a wall 18 protruding from an outer edge of the face 16. The face 16 may include an opening 20 for receiving the shaft 14 therethrough. The wall 18 may include an outer surface 22 and an inner surface 24. The outer surface 22 may include a plurality of teeth or gears 26. The inner surface 24 may be machined to facilitate a specified straightness and fit, as discussed further below.

The clutch assembly 10 may include a plurality of plates 28, such as friction plates. The plates 28 may be configured to engage the outer surface 22 hub 12 and rotate therewith. For example, the plates 28 may include teeth arranged to engage the gears 26 of the hub 12. The plates 26 may selectively engage an outer housing based on the selected gearing ratio. For example, the clutch assembly 10 may compress the plates 28, using fluid pressure or otherwise, to engage the plates 28 with the outer housing 18 to move in unison with the hub 12.

In operation, the engagement between the plates 28 and the outer housing that occurs when the transmission changes gears may cause unwanted noise and vibrations on the hub 12. For example, the plates 28 may include outer teeth or gears that may engage openings in the outer housing and may cause unwanted ringing or vibration. The hub 12 may therefore be equipped with a damper to reduce the unwanted ringing and vibration.

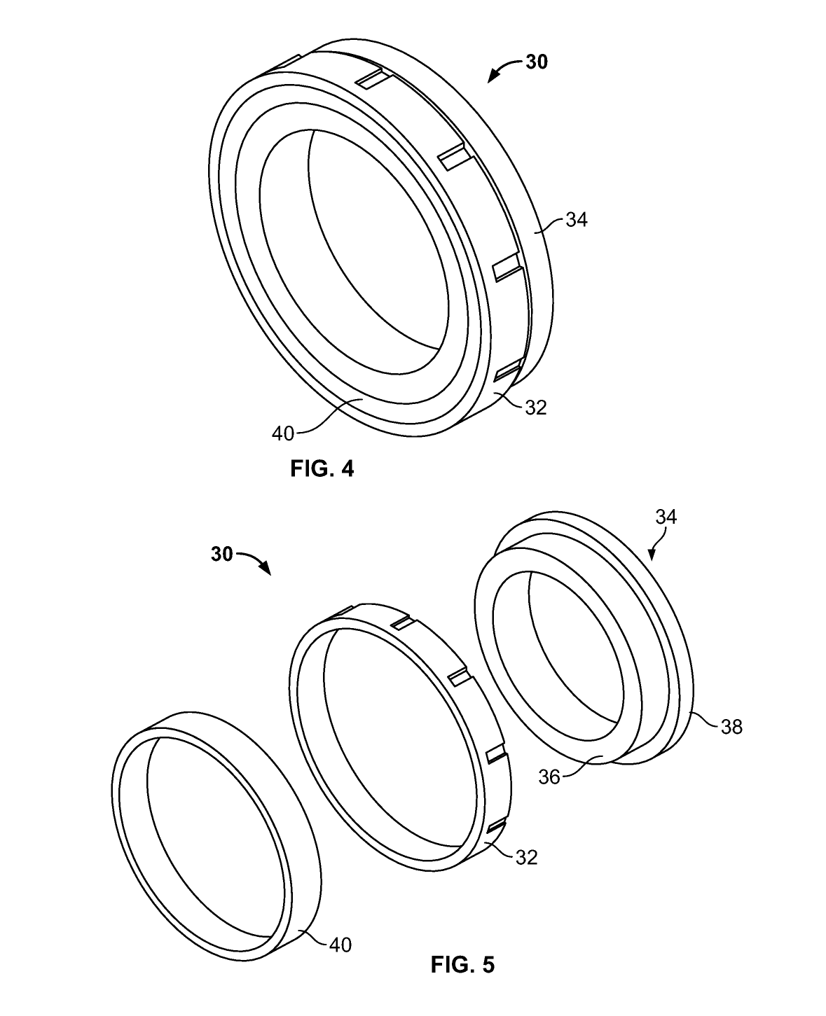

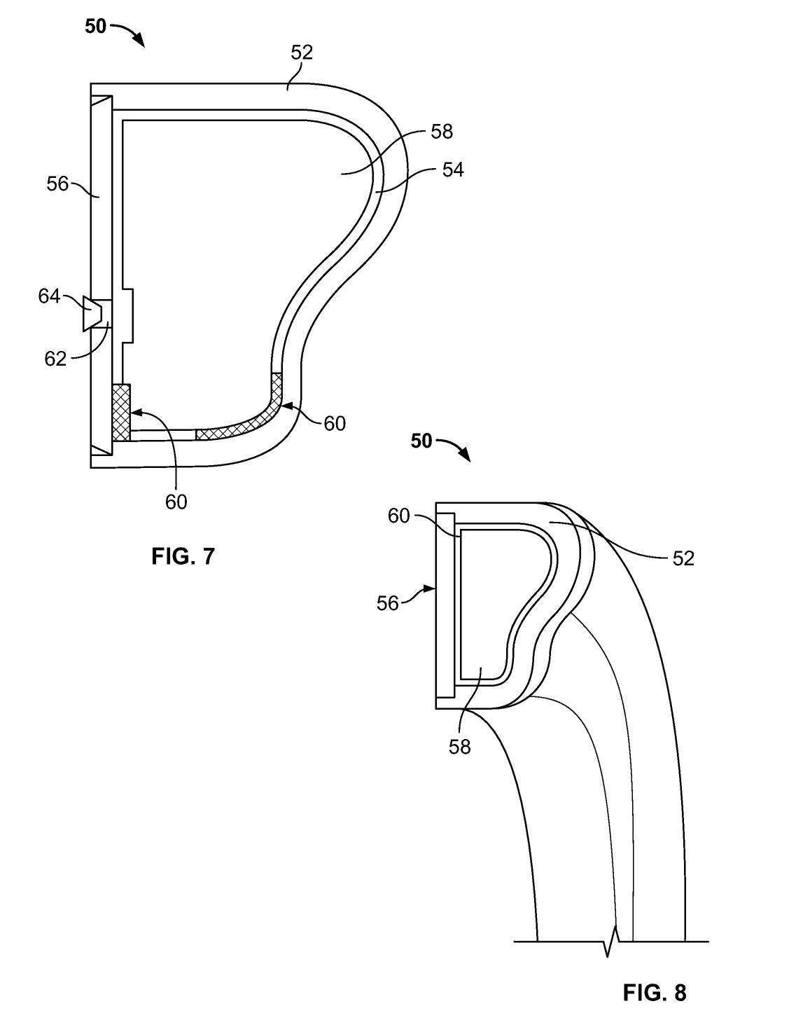

FIGS. 3-8 generally illustrate a clutch damper 30. The clutch damper 30 may be connected to the hub 12 and positioned to nest inside the cylindrical opening in the hub 12. The damper may dampen and absorb the unwanted vibrations.

In an embodiment, the damper 30 may include a mounting ring 32, as shown in FIGS. 3-5. The mounting ring 32 may comprise an annular ring composed of any appropriate material. The mounting ring 32 may be configured to mount to the inner surface 22 of the hub. For example, the inner surface 22 may be machined to receive the mounting ring 32 in a press-fit configuration. Alternatively, the mounting ring may be welded or otherwise connected to the inner surface 22 of the hub 12.

The damper 30 includes an inertia member, such as an inertia member 34. The inertia member 34 may be generally circular or cylindrically shaped, and sized to fit within at least a portion of the mounting ring 32. For example, the inertia member 34 may have an L-shaped cross-section, as shown in FIG. 3. A first portion of the inertia member 34 may form an inner ring 36 that fits within the mounting ring 32. A second portion of the inertia member 34 may form a top ring 38 that extends over the mounting ring 32.

The damper 30 may include an elastomeric member 40. The elastomeric member 40 may be annular shaped and formed out of any appropriate elastomeric material, such as rubber. The elastomeric member may be positioned between the inertia member 34 and the mounting ring 32. For example, the elastomeric member 40 may be positioned between the inner ring 36 and the inside of the mounting ring 32 in a concentric arrangement, allowing the inner ring 36 to protrude through an opening in the annular elastomeric member 40

While the damper 30 is shown and described as including the mounting ring 32, it will be appreciated that the damper 30 may be connected directly to the hub 12 without use of a mounting ring 32. For example, the elastomeric member 40 may be directly connected to the inner surface 24 of the hub 12.

The damper 30 may be tuned to absorb and reduce the system's resonant vibrations. Specifically the mass of the inertia member 34 and thickness and stiffness of the elastomeric member 40 may be tuned to dampen the resonant noise and vibrations caused by the contact between the hub 12 and the outer housing. The damper 30 may be tuned to dampen both torsional and bending frequencies. The inertia member 34 may provide the inertia necessary to control the vibration and the elastomeric member 40 may provide the desired stiffness to dampen the resonant frequencies by converting the vibration energy to heat.

The damper 30 may include a plurality of openings to allow lubrication to enter and flow through the system. The openings may be any appropriate shape and size and may be arranged to allow oil or any lubricant to flow through and around the damper to various components of the clutch assembly 10.

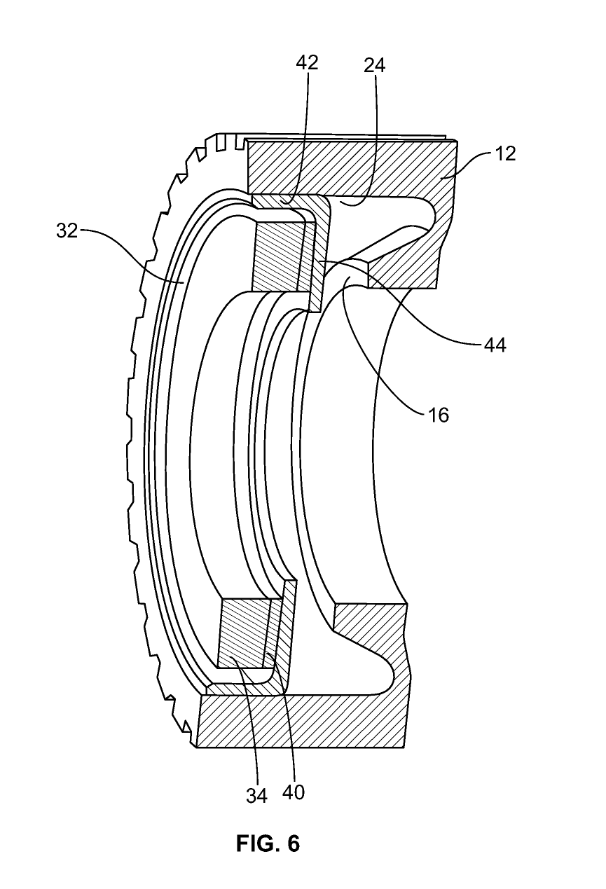

In an embodiment, the inertia ring 34 and elastomeric member 40 may be configured in a stacked arrangement, as shown in FIG. 6. For example, the elastomeric member 40 may be connected, directly or indirectly, to the face 16 of the hub 12. The inertia ring 34 may be connected to the elastomeric member 40 on the opposite side of the face 16.

In an embodiment, a mounting ring 32 may be positioned between the elastomeric member 40 and the face 16 of the hub 12. The mounting ring 32 may be connected directly to the inside of the face 16. As shown in FIG. 6, the mounting ring 32 may include a first portion 42 connected to the inner surface 24 and a second portion 44 to form a surface approximately parallel with the face 16 of the hub 12. The second portion 44 may be connected to the face 16, as described above, or may be positioned a distance away from the face 16. The elastomeric member 40 may connect directly to the second surface 44 and the inertia ring 34 may be connected to the elastomeric member 40, as shown in FIG. 6.

In an embodiment, the clutch assembly 10 may include a viscous damper 50. The viscous damper 50 may be configured to engage the hub 12 and dampen unwanted vibrations using friction and viscosity.

The viscous damper 50 may include a housing 52. The housing 52 may be generally circular or annular to form a hollow ring having a cavity 54 inside. The housing 52 may be sized and shaped to fit within and connect to the hub 12. For example, the housing may connect to the inner surface 24 of the hub 12. Alternatively, the inner surface 24 may form a portion of the housing 52. One surface of the housing 52 may comprise a cover 56. The cover 56 may be removable to provide access to the cavity 54, and may be fixed to the housing 52 by any appropriate means, such as laser welded to the housing. The cover 56 may comprise a generally flat ring configured to connect to the inner surface 24 of the hub 12.

An inertia ring 58 may be located within the cavity 54. The inertia ring 58 may be generally annular and sized and shaped to fit within the cavity with a specified clearance. The clearance or remaining area within the cavity may be filled with a viscous fluid 60, such as silicon or any appropriate viscous fluid. The fluid 60 may be input into the cavity 54 or drained from the cavity 54 through a port 62. The port 62 may be accessible via plug 64, such as a weld plug, that may be inserted into the port 62 once the fluid 60 has been into the cavity.

The viscous damper 50 may be tuned to absorb and reduce torsional frequencies on the hub 12. For example, the mass of the inertia ring 58, thickness or viscosity of the fluid 60, and clearance within the cavity 54 may be adjusted and tuned to dampen resonant frequencies within the system.

The inertia ring 58 may provide the inertia necessary to control the vibration within the clutch assembly 10, while the fluid 60 may dampen the resonant frequencies by converting the vibration energy to heat. The inertia ring 58 may move within the cavity 54 with respect to the fluid 60, thereby creating a friction or shearing force to convert the vibrations to heat.

The invention has been described above and modifications and alterations will occur to others upon a reading and understanding of this specification. The claims as follows are intended to include all modifications and alterations insofar as they come within the scope of the claims or the equivalent thereof.

1. A clutch damper operatively connected to a hub positioned about a drive shaft, the clutch damper comprising:
an inertia member having a first portion;
an elastomeric member connected to said inertia member; and
a mounting ring configured to operatively connect to said hub,
wherein the elastomeric member is positioned between said inertia member and said mounting ring.

2. The clutch damper of claim 1, wherein the elastomeric member includes an inner diameter, and further wherein said inertia member is positioned within said inner diameter.

3. (canceled)

4. The clutch damper of claim 1 wherein said mounting ring is positioned between said elastomeric member and said hub.

5-6. (canceled)

7. The clutch damper of claim 1, wherein said inertia member further comprises:
a second portion connected to said first portion, and wherein said first and second portions form an L-shaped cross-section.

8. The clutch damper of claim 1, wherein said inertia member is annular shaped.

9. (canceled)

10. The clutch damper of claim 1, wherein said elastomeric member is composed of rubber.

11. (canceled)

12. The clutch damper of claim 10, wherein said inertia member and elastomeric member are tuned to dampen one or more vibration frequencies within said clutch assembly.

13. The clutch damper of claim 1, wherein said mounting ring includes a first portion connected to an inner wall of said hub and a second portion extending from said first portion, and wherein said elastomeric member is connected to said second portion.

14. A clutch assembly comprising:
a clutch damper comprising:
a housing having a cavity therein;
an inertia member positioned within said cavity; and
a fluid surrounding said inertia member within said cavity; and
a hub positioned about a drive shaft, wherein said clutch damper is operatively connected to said hub.

15. The clutch assembly of claim 14, wherein said housing is annular shaped.

16. The clutch assembly of claim 15, wherein said housing comprises a cover removably connected to said housing.

17. The clutch assembly of claim 16, wherein said cover includes a port providing access to said cavity.

18. The clutch assembly of claim 14, wherein said hub comprises:
a base having a circular shape and an opening therein;
a wall protruding from said base; and
wherein said opening in said base is operatively positioned on a shaft within said clutch assembly.

19. The clutch assembly of claim 14, wherein said fluid is silicon.

20. The clutch assembly of claim 14, wherein said inertia member and elastomeric member are tuned to dampen one or more vibration frequencies within said clutch assembly.

21. A clutch assembly comprising:
a hub comprising:
a base having a generally circular shape and an opening therein; and
a wall protruding generally perpendicularly from said base,
wherein said opening in said base is operatively positioned on a drive shaft within said clutch assembly; and
a clutch dampener comprising:
an inertia member; and
an elastomeric member connected to said inertia member,
wherein said clutch damper is operatively connected to said hub.

22. The clutch assembly of claim 21, wherein said hub further comprises:
a plurality of teeth on an outer surface of said wall and configured to operatively engage one or more plates.

23. The clutch assembly of claim 21, wherein said inertia member and said elastomeric member are tuned to dampen one or more vibration frequencies from said hub.

24. The clutch assembly of claim 21, wherein the clutch dampener further comprises:
a mounting ring, said mounting ring operatively connected to an inner surface of said wall of said hub.

25. The clutch assembly of claim 21, wherein the elastomeric member is directly connected to an inner surface of said wall of said hub.
